(19) United States
(12) Patent Application Publication
(10) Pub. No.: US 2017/0120264 A1
(43) Pub. Date: May 4, 2017

(54) MULTIFUNCTIONAL SHOWER HEAD

(71) Applicants: Huasong Zhou, Xiamen (CN); XIAMEN SOLEX HIGH-TECH INDUSTRIES CO., LTD., Xiamen (CN)

(72) Inventors: Fengde LIN, Xiamen, Fujian (CN); Mingfu ZHANG, Xiamen, Fujian (CN); Wenxing CHEN, Xiamen, Fujian (CN)

(73) Assignees: XIAMEN SOLEX HIGH-TECH INDUSTRIES CO., LTD., Xiamen (CN); Huasong Zhou, Xiamen (CN)

(21) Appl. No.: 15/270,665

(22) Filed: Sep. 20, 2016

(30) Foreign Application Priority Data
Nov. 2, 2015 (CN) 201510732400.6

(51) Int. Cl. B05B 1/30; B05B 12/00; B05B 15/06; B05B 1/18

(52) U.S. Cl. CPC B05B 1/3026; B05B 1/18; B05B 12/002; B05B 15/065

(57) ABSTRACT

A multifunctional shower head includes a shower head main body, a dial button component, a cyclic witch component and a water stop switch component. The dial button component includes a dial button exposed out of the shower head main body and a switch fitting element and a water stop fitting element linked to the dial button; when the dial button moves to one side, the water stop fitting element moves away from the water stop switch component and the switch fitting element to abuts against the cyclic switch component. Driving a water diversion plate of the cyclic switch component to rotate, changes the relative position of the water diversion plate and the water diversion body. When the dial button moves to another side, the switch fitting element moves away from the cyclic switch component and the water stop fitting element abuts against the water stop switch component.

### FIELD OF THE INVENTION

The present invention relates to a shower head, especially to a multifunctional shower head.

### BACKGROUND OF THE INVENTION

Traditional shower head with multiple outlet functions mostly uses a kind of button to switch the outlet functions, when the button is operated, the outlet type of the shower head changes correspondingly. With the development of the shower head structure and the function, a shower head that can achieve low volume water stop comes out, this kind of shower head can achieve low volume water stop when the user is smearing shampoo or bath cream, compared to the fully water stop traditional shower head, this kind of low volume water stop shower head still has low volume water flowing out when in water-stop state, therefore, it would make the temperature of the shower space not dropping down quickly, it not only saves water, but also provides well experience to the user. However, this kind of water stop shower head needs extra button to achieve the low volume water stop function, it makes the shower head structure complicated and not simple. The unclear operation also increases the learning cost to the shower head.

### SUMMARY OF THE INVENTION

The present invention solves the main technical problems of the existing technology and provides a multifunctional shower head, when the dial button swags to one side, the outlet modes of the shower head are switched circularly, when the dial button swags to the other side, the shower head is closed; when the water stop mode is switched to water flowing mode, it needs light force and it has well hand feeling.

The technical proposal of the present invention is that:

A multifunctional shower head, wherein comprising a shower head main body, a dial button component, a cyclic witch component and a water stop switch component; the dial button component comprises a dial button exposed out of the shower head main body and a switch fitting element and a water stop fitting element linked to the dial button;

when the dial button swags to one side, the water stop fitting element leaves away from the water stop switch component and the switch fitting element to abut against the cyclic switch component, thus driving a water diversion plate of the cyclic switch component to rotate to change the relative position of the water diversion plate and the water diversion body, so that different outlet of the water diversion body is connected to achieve waterway switch;

when the dial button swags to another side, the switch fitting element leaves away from the cyclic switch component and the water stop fitting element to abut against the water stop switch component, thus driving a water stop valve of the water stop switch component to close the inlet of the high volume to achieve water stop;

the switch fitting element and the water stop fitting element are two independent parts, so that the water pressure due to water stop fully acts on the water stop fitting element and the water stop switch component.

In another preferred embodiment, the switch fitting element is a one-way driving pawl linked to the dial button coaxially.

In another preferred embodiment, the cyclic switch component is disposed with a driving pawl seat sleeved on the one-way driving pawl; the internal periphery of the dial button is disposed with a protruding block fitting to the one-way driving pawl; when the dial button swags to one side, the protruding block abuts against the one-way driving pawl to drive the one-way driving pawl to rotate; when the dial button swags to another side, the protruding block rotates to leave away from the one-way driving pawl, thus releasing the abutting and fitting relationship of the one-way driving pawl and the protruding block.

In another preferred embodiment, the cyclic switch component is further disposed with an one-way intermittent driving element, one end of the one-way intermittent rotating element is fixedly connected to the driving pawl seat, the other end of the one-way intermittent rotating element is connected to the water diversion plate; the one-way intermittent driving element drives the water diversion plate to rotate in one-way intermittently.

In another preferred embodiment, the one-way intermittent rotating element is disposed with a switch pawl and a ratchet wheel sleeved on the switch pawl, the internal periphery of ratchet wheel is disposed with internal ratchets coupling to the switch pawl; when the switch pawl rotates towards the direction abutting against the internal ratchet, the ratchet wheel rotates a certain angle corresponding to the internal ratchet.

In another preferred embodiment, the external periphery of the ratchet wheel is further disposed with an external ratchet with equal size with the internal ratchet and opposite direction; a stop pawl is configured to abut against the external ratchet.

In another preferred embodiment, the one-way intermittent rotating element further comprises a switch pawl seat to hold the switch pawl, the switch pawl seat is fixedly connected to a tension spring; when the switch pawl rotates towards the direction abutting against the internal ratchet, the tension spring is pulled.

In another preferred embodiment, the water stop fitting element is a cam coaxially linked to the dial button.

In another preferred embodiment, the water stop switch component comprises a rotating block, the side of the rotating block facing to the cam is disposed with an incline surface; when the dial button swags towards the other side, the cam rotates towards the rotating block, so that the cam abuts against the incline surface to drive the rotating block to rotate about the pivot of the rotating block; the rotating block rotates to abut against the water stop valve to make the water stop valve move from the first position to the second position, so that the high volume inlet in the shower head main body is closed.

In another preferred embodiment, the water stop valve is disposed with a low volume inlet with continuously water flowing, a Y-shaped ring is disposed between the valve body of the water stop valve and the internal wall of the shower head main body; when the Y-shaped ring is disposed faced to the low volume inlet, water flows to the shower head main body through the low volume inlet to achieve low volume water stop; when the Y-shaped ring is disposed opposite to the low volume inlet, water is stopped by the Y-shaped ring after flowing through low volume inlet to achieve water stop.

In another preferred embodiment, the water stop valve is connected to the reset spring, when the abutting of the cam and the rotating block is released, the reset spring drives the water stop valve to reset to the first position from the second position.

Compared to the existing known technology, the technical proposal of the present invention has advantages as follows:

1. The multifunctional shower head of the present invention is disposed with the button and the switch fitting element and the water stop fitting element linked to the dial button, when the dial button rotates to different direction, one of the switch fitting element and the water stop fitting element works, so that one dial button rotating to different direction can achieve two functions of outlet function switch and low volume water stop. Therefore, the switch fitting element and the water stop fitting element are independent, the two functions of outlet function switch and the water stop don't conflict, the structure and the operation stability are better. As the switch fitting element and the water stop fitting element are disposed independently, when in the water stop mode, only the water stop fitting element is pressed by the water pressure, the switch fitting element is not influenced. Therefore, when it is switched from the water stop mode to the water flowing mode, it needs small force to switch the switch fitting element, the operating hand feel is better.

2. The multifunctional shower head of the present invention is provided that, the cyclic switch component coupled to the switch fitting element is further disposed with a one-way intermittent rotating element, which makes the water diversion plate rotate a fixed angle each time with the coupling of the driving pawl and the internal ratchet of the ratchet wheel. So that the user can feel a specific gearing when switching the outlet, it also has well hand feeling and accurate operating.

3. The multifunctional shower head of the present invention is provided that, the one-way intermittent rotating element further comprises a stop pawl abutting fitting to the external ratchet of the ratchet wheel, the external ratchet has opposite direction to the internal ratchet. So that when the driving pawl is coupled to the internal ratchet of the ratchet wheel, it needs to overcome the abutting force of the stop pawl and the external ratchet of the ratchet wheel, it thus improves the hand feeling. When the ratchet wheel rotates in an angle corresponding to one internal ratchet, the stop pawl leaves away from the external ratchet and resets to abut against the next external ratchet in the rotating direction of the ratchet wheel. Therefore, the stop pawl and the external ratchet reset to abut against each other after the user rotates the dial button once, it prevents the ratchet wheel from drawing back when the switch pawl rotates backwardly, it thus makes the gearing feeling more specific.

4. The multifunctional shower head of the present invention is provided that, the driving pawl would reset automatically under the action of the tension spring when the user releases the dial button, so that the dial button is always in the initial position when the user operates the dial button, it makes the operation convenient and smooth.

5. The multifunctional shower head of the present invention is provided that, as the low volume outlet is disposed in the water stop valve in running through way, whether the water stop valve is in the first position or the second position, as the low volume outlet connects the two sides of the water stop valve, the water pressure difference of two sides of the water stop valve is significantly reduced. So that the user only needs to overcome the elastic force of the reset spring, thus ensuring the water stop operating hand feeling.

6. The multifunctional shower head of the present invention is provided that, a Y-shaped ring is disposed between the water stop valve and the shower head main body, when the Y-shaped ring is disposed faced to the low volume inlet, water flows to the shower head main body through the low volume inlet to achieve low volume water stop; when the Y-shaped ring is disposed opposite to the low volume inlet, water is stopped by the Y-shaped ring after flowing through low volume inlet to achieve fully water stop. Therefore, it can choose fully water stop or low volume water stop by adjusting the direction of the Y-shaped ring.

### BRIEF DESCRIPTION OF THE DRAWINGS

FIG. 1 illustrates an exploded and schematic diagram of a preferred embodiment of the present invention.

FIG. 2 illustrates a sectional diagram of the embodiment of the present invention.

FIG. 3 illustrates a schematic diagram of the dial button component of the embodiment of the present invention.

FIG. 4 illustrates a schematic diagram of the one-way intermittent rotating element of the embodiment of the present invention.

FIG. 5 illustrates a sectional diagram of the shower head with of the embodiment of the present invention with the indication of the position of the water diversion plate when the outlet function is inner ring water.

FIG. 6 illustrates a sectional diagram of the shower head of the embodiment of the present invention with the indication of the position of the water diversion plate when the outlet function is mixing water.

FIG. 7 illustrates a sectional diagram of the shower head of the embodiment of the present invention with the indication of the position of the water diversion plate when the outlet function is outer ring water.

FIG. 8 illustrates a sectional diagram of the shower head of the embodiment of the present invention with the indication of the position of the cam and the rotating block when the dial button is situated in the initial position.

FIG. 9 illustrates a sectional diagram of the shower head of the embodiment of the present invention with the indication of the water flowing state when the dial button is situated in the initial position.

FIG. 10 illustrates a sectional diagram of the shower head of the embodiment of the present invention with position of the cam and the rotating block when the dial button rotates in the counter-clockwise direction.

FIG. 11 illustrates a sectional diagram of the shower head of the embodiment of the present invention in low volume water stop state when the dial button rotates in the counter-clockwise direction.

FIG. 12 illustrates a sectional diagram of the shower head of the embodiment of the present invention in fully water stop state when the dial button rotates in the counter-clockwise direction.

### DETAILED DESCRIPTION OF THE EMBODIMENTS

The present invention will be further described with drawings and the embodiments.

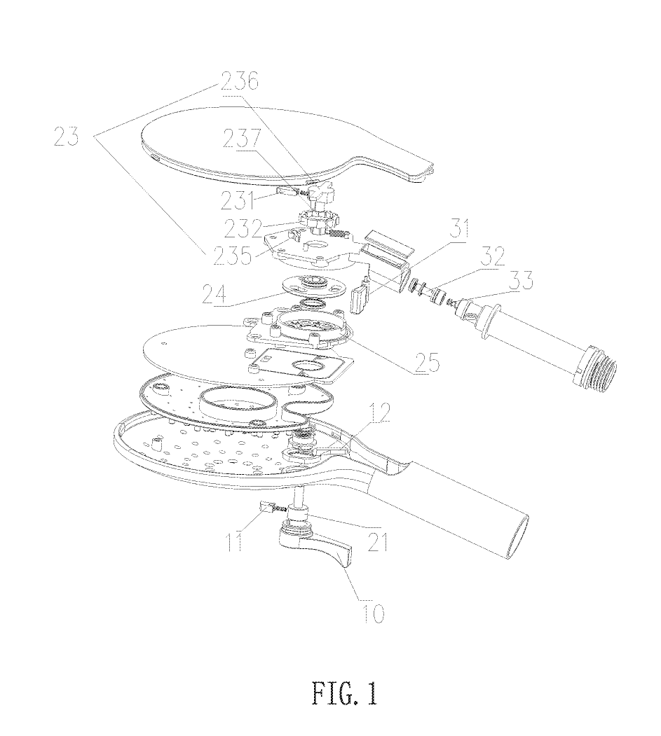

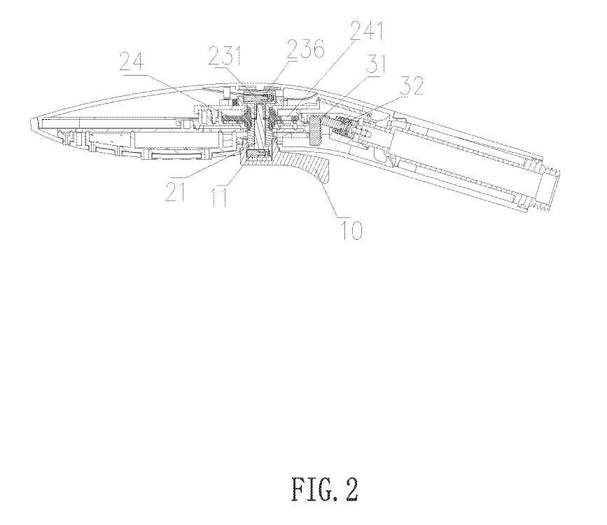

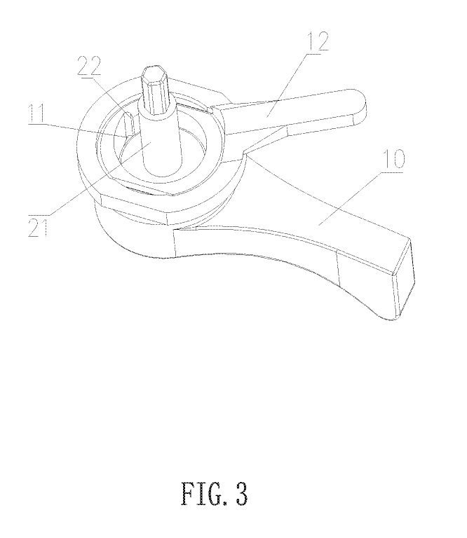

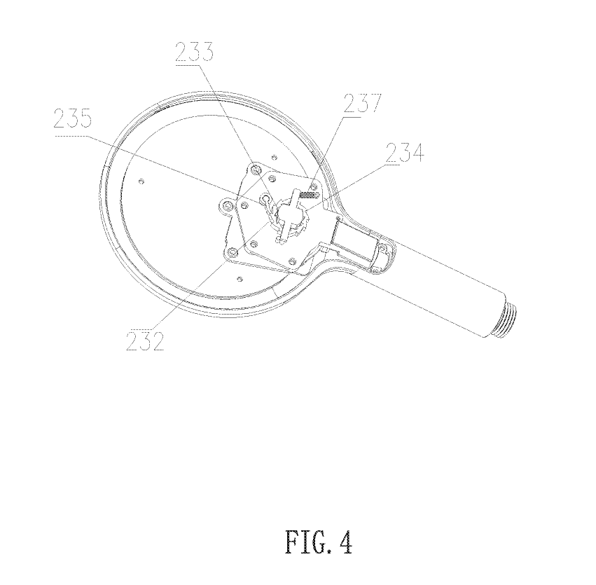

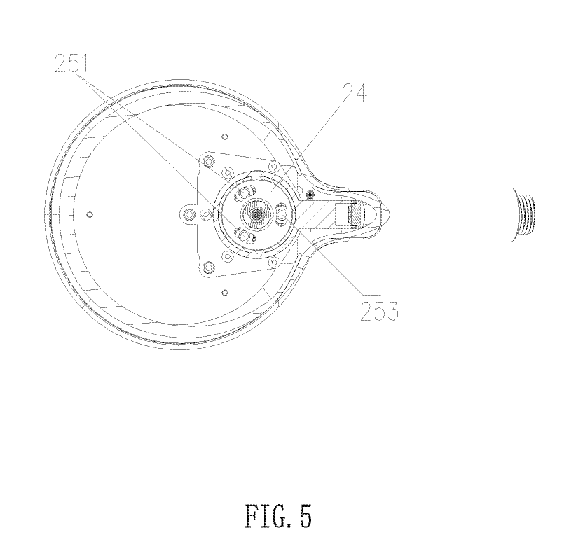

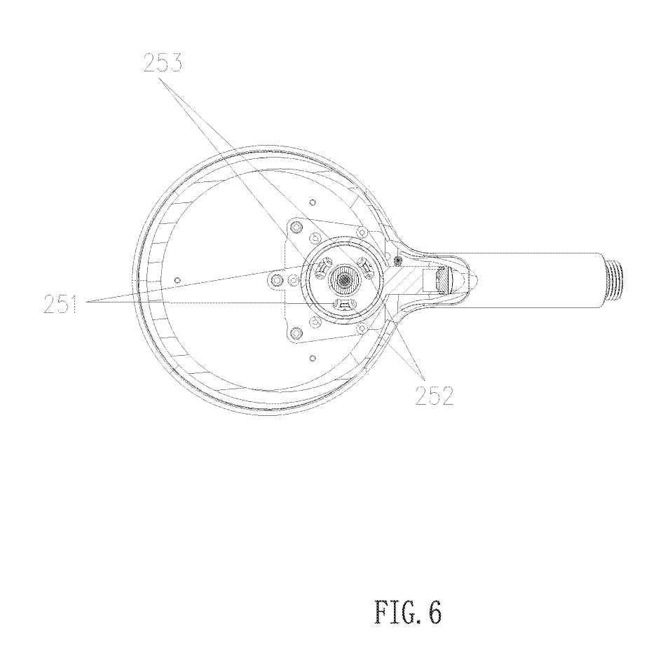

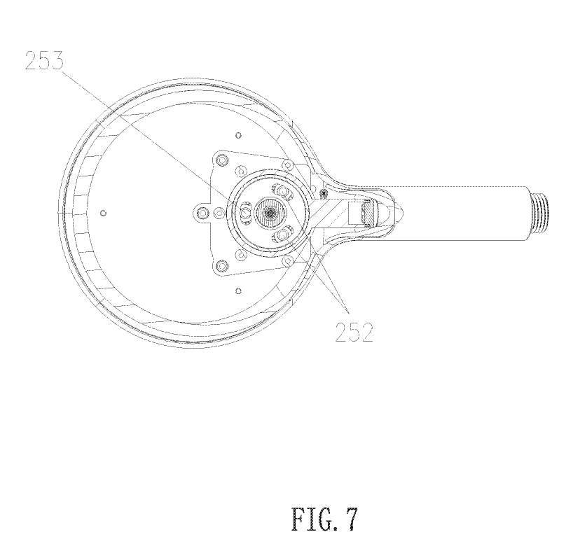

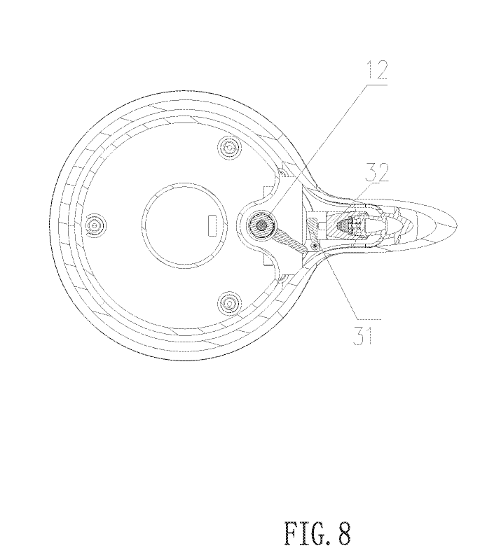

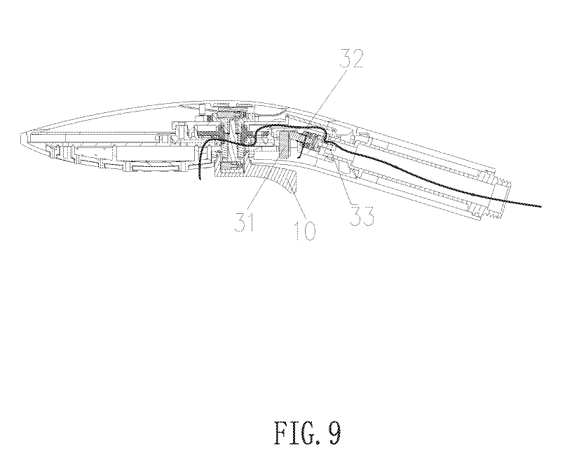

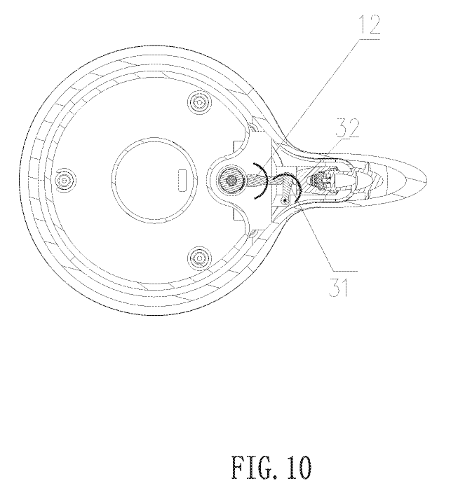

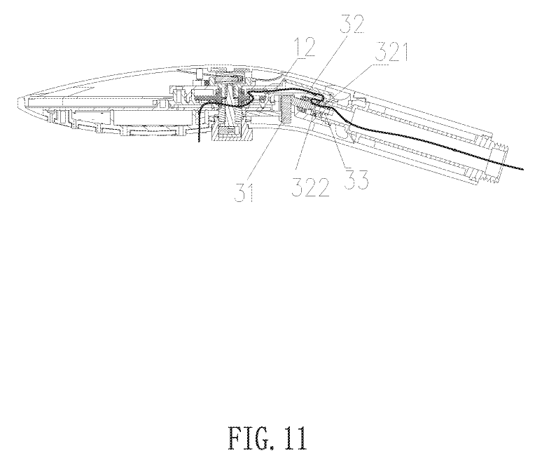

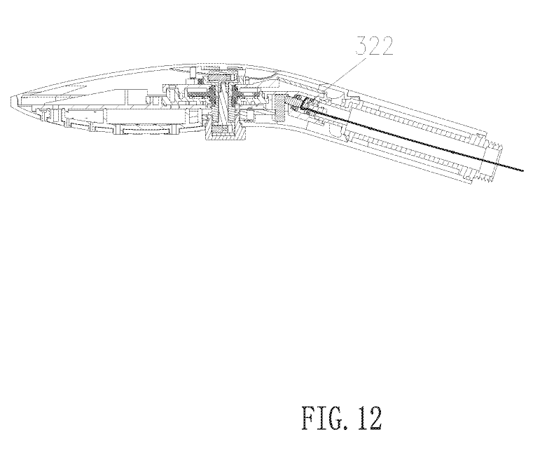

Referring to FIGS. 1-12, a multifunctional shower head with dial button comprises a shower head main body, a dial button component, a cyclic switch component and a water stop switch component; the dial button component comprises a button 10 exposed out of the shower head main body, a switch fitting element linked to the dial button and a water stop fitting element;

The switch fitting element is a one-way driving pawl linked to the dial button 10 coaxially.

The cyclic switch component is disposed with a driving pawl seat 21 sleeved on the one-way driving pawl 11; the internal periphery of the dial button 10 is disposed with a protruding block 22 fitting to the one-way driving pawl 11. When the dial button 10 is situated in the central portion, the protruding block 22 abuts against the one-way driving pawl 11; when the dial button 10 swags in the clockwise direction, with the action of the abutting force, the protruding block 22 drives the one-way driving pawl 11 to rotate so as to drive the driving pawl seat 21 to rotate coaxially; when the dial button 10 swags in the counter-clockwise direction, the protruding block 22 leaves away from the one-way driving pawl 11 to unfreeze the abutting of the one-way driving pawl 11 and the protruding block 22. Therefore, only when the dial button 10 rotates in the clockwise direction, the ratchet seat 21 is linked to the dial button; when the dial button 10 rotates in the counter-clockwise direction, the ratchet seat 21 keeps still.

The cyclic switch component is further disposed with an one-way intermittent rotating element 23, one end of the one-way intermittent rotating element 23 is fixedly connected to the driving pawl seat 21, the other end is connected to the water diversion plate 24; as one end of the one-way intermittent rotating element 23 is fixedly connected to the driving pawl seat 21, when the dial button 10 rotates in the clockwise direction, the one-way intermittent rotating element 23 rotates synchronously so as to drive the water diversion plate to achieve one-way intermittent rotating. With the rotating of the water diversion plate 21, the relative position of the water diversion plate 21 and the water diversion body changes, the through hole 241 of the water diversion plate is connected to different outlet of the water diversion body, so that it can achieve different outlet effect. In this embodiment, the water diversion body 24 has two inner ring outlets 251, two outer ring outlets 252 and two blind holes 253. When the through hole 241 of the water diversion plate 24 is connected to the inner ring outlets 251, the outlet function is inner ring water; when the through hole 241 of the water diversion plate 24 is connected to the outer ring outlets 252, the outlet function is outer ring water; when the through hole 241 of the water diversion plate 24 is respectively connected to the inner ring outlets 251 and the outer ring outlets 252, the outlet function is mixture water. Therefore, it can achieve that by rotating the dial button 10 in the clockwise direction, the outlet functions are switched cyclically.

The one-way intermittent rotating element 23 is disposed with a switch pawl 231 and a ratchet wheel 232 sleeved on the switch pawl 231, the internal periphery of ratchet wheel 232 is disposed with internal ratchets 233 coupling to the switch pawl 231; when the ratchet seat 21 rotates in the clockwise direction, the switch pawl 231 is driven to rotate towards the direction to abut against the internal ratchet, so that abutting force generates to drive the ratchet wheel 232 to rotate, when the ratchet wheel 232 rotates in an angle corresponding to one internal ratchet 233, the switch pawl 231 abuts against the next internal ratchet 233 in the rotating direction, therefore, the ratchet wheel can intermittently rotate, each rotating angle is fixed. So that the user can feel a specific gearing when switching the outlet, it also has well hand feeling and accurate operating.

To further improve the hand feeling when the user switches the outlet functions cyclically, the external periphery of the ratchet wheel 232 is further disposed with an external ratchet 234 with equal size with the internal ratchet 233 and opposite direction; a stop pawl 235 is configured to abut against the external ratchet 234; when the ratchet wheel 232 rotates in the clockwise direction, the stop pawl 235 swags towards the direction away from the ratchet wheel 232 as with the abutting force between the stop pawl 235 and the external ratchet 234; when the ratchet wheel 232 rotates in an angle corresponding to one internal ratchet 233, the stop pawl 235 resets and abuts against the next external ratchet 234 in the rotating direction of the ratchet wheel. Therefore, when the driving pawl 231 is coupled to the internal ratchet 233 of the ratchet wheel 232, it needs to overcome the abutting force between the stop pawl 235 and the external ratchet 234 of the ratchet wheel 232 so as to improve the hand feeling. When the ratchet wheel 232 rotates in an angle corresponding to one internal ratchet 233, the stop pawl 235 leaves away from the external ratchet 234 and resets to abut against the next external ratchet 234 in the rotating direction of the ratchet wheel 232. Therefore, the stop pawl 235 and the external ratchet 234 reset to abut against each other after the user rotates the dial button once, it prevents the ratchet wheel 232 from drawing back when the switch pawl 231 rotates backwardly, it thus makes the gearing feeling more specific.

If the user rotates the dial button 10 to switch a gear and the dial button then stops in the rotated position, the dial button would be situated in different position each time the user switches the outlet function, it goes against the user to operate skillfully, and when the dial button is in different position, the gesture to rotate the dial button 10 is different that it makes it uncomfortable. To eliminate this negative factor, the one-way intermittent rotating element 23 further comprises a switch pawl seat 236 to hold the switch pawl 231, the switch pawl seat 236 is fixedly connected to a tension spring 237. So that when the user releases the force to the dial button 10, the switch pawl seat 236 drives the switch pawl 231 to reset under the action of the reset force of the tension spring 237, so that the ratchet seat 21 drives the dial button 10 to reset.

Therefore, each time after the user rotates the dial button to switch the gear, the dial button would reset to the initial position, the user uses the same force to switch the gear and the gesture is similar.

The water stop fitting element is a cam 12 coaxially linked to the dial button 10.

The water stop switch component comprises a rotating block 31, when the dial button 10 swags in the counter-clockwise direction, the cam 12 rotates towards the rotating block 31, the side of the rotating block 31 faced to the cam 12 is disposed with an incline surface coupled to the cam 12. When the cam 12 abuts against the rotating block 31, the abutting force makes the rotating block 31 rotates about its pivot; the rotating block 31 rotates to abut against the water stop valve 32 to make the water stop valve 32 move from the first position to the second position, so that the high volume inlet in the shower head main body is closed to achieve water stop.

In this embodiment, the water stop has two modes: the low volume water stop and fully water stop, the detailed structure is that:

A low volume inlet 321 is disposed in the water stop valve 32 to keep in water flowing, a Y-shaped ring 322 is disposed between the water stop valve 32 and the shower head main body.

When the Y-shaped ring 322 is disposed faced to the low volume inlet 321, if the water stop valve 32 is in the second position, water flows to the shower head main body out of the outlet from the Y-shaped ring 322 through the low volume inlet 321 to achieve low volume water stop;

When the Y-shaped ring 322 is disposed opposite to the low volume inlet 321, if the water stop valve 32 is in the second position, water is stopped by the Y-shaped ring 322 after flowing through low volume inlet 321 to achieve water stop, water can't flow to the inner side of the shower head main body, at this time, it achieves fully water stop.

When the dial button 10 rotates in the counter-clockwise direction, the shower head main body achieves low volume water stop or fully water stop, so that it just needs to adjust the direction of the Y-shaped ring to switch the two water stop modes, it is convenient. The water stop modes are suitable when the user needs to close the shower water in a short time, like when smearing the shampoo or bath cream.

As the rotating block 31 and the cam 12 are coupled in incline surface abutting way, even the user releases the button 10, the abutting and the coupling also exist, the dial button 10 would not reset automatically. When the user needs low volume water stop or fully water stop, it only needs to rotate the dial button in counter-clockwise direction to release the dial button, it doesn't need long time to keep pushing the dial button.

In this embodiment, the water stop valve 32 is connected to the reset spring, when the user dials the dial button to the initial position, the abutting coupling between the cam 12 and the rotating block 31 is released, the reset spring 33 drives the water stop valve 32 to the first position from the second position. Therefore it finishes the process of the shower head from low volume water stop or fully water stop to the normal outlet.

It can be seen from above, when in fully water stop, water is closed by the water stop valve 32, the water pressure works on the water stop valve 32, the cam 12 and the rotating block 31; as the switch fitting element and these components are independent, when in the fully water stop state, the switch fitting element isn't influenced by the water pressure. When in the low volume water stop, although there is low volume water flowing to the shower head main body, the water is flowing out of the outlet of the shower head main body, the switch fitting element is not influenced by the water pressure neither. So that it doesn't need to overcome the water pressure when the user dials the dial button 10 from the water stop position to the initial position, it significantly reduces the needed force, thus ensuring the operating hand feeling.

Moreover, as the low volume outlet 321 is disposed in the water stop valve 32 in running through way, when the water stop valve 32 is in the first position, as the low volume outlet 321 connects two sides of the water stop valve, the water pressure difference of two sides of the water stop valve 32 is significantly reduced. So that the force to push the water stop valve is significantly reduced, it is approximately that the user only needs to overcome the elastic force of the reset spring 33, thus ensuring the water stop operating hand feeling.

With above mentioned configuration, it needs small force to switch the water flowing mode and the water stop mode for the user, thus making it with well operating hand feeling.

The multifunctional shower head is provided that, when the dial button swags in the clockwise direction, the water stop fitting element leaves away from the water stop switch component, the switch fitting element abuts against the cyclic switch component to drive the water diversion plate of the cyclic switch component to rotate so as to change the relative position of the water diversion plate and the water diversion body, making different outlet of the water diversion body connected, thus achieving the switch of the waterway;

When the dial button swags in the counter-clockwise direction, the switch fitting element leaves away from the cyclic switch component, the water stop fitting element abuts against the water stop switch component to drive the water stop valve of the water stop switch component to close the high volume inlet, the low volume inlet has water flowing through, thus achieving low volume water stop or fully water stop.

As the water stop fitting element and the switch fitting element are independent without influence, the outlet function switch and the low volume water stop are not conflict, the structure and the operating stability are better. This kind of shower head has new switch mode, it only needs a single hand to achieve cyclic switch and water stop switch, the switch structure is stable and reliable, and the switch hand feeling is better.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A multifunctional shower head, wherein comprising a shower head main body, a dial button component, a cyclic witch component and a water stop switch component; the dial button component comprises a dial button exposed out of the shower head main body and a switch fitting element and a water stop fitting element linked to the dial button;
when the dial button swags to one side, the water stop fitting element leaves away from the water stop switch component and the switch fitting element to abut against the cyclic switch component, thus driving a water diversion plate of the cyclic switch component to rotate to change the relative position of the water diversion plate and the water diversion body, so that different outlet of the water diversion body is connected to achieve waterway switch;
when the dial button swags to another side, the switch fitting element leaves away from the cyclic switch component and the water stop fitting element to abut against the water stop switch component, thus driving a water stop valve of the water stop switch component to close the inlet of the high volume to achieve water stop;
the switch fitting element and the water stop fitting element are two independent parts, so that the water pressure due to water stop fully acts on the water stop fitting element and the water stop switch component.

2. The multifunctional shower head according to claim 1, wherein the switch fitting element is a one-way driving pawl linked to the dial button coaxially.

3. The multifunctional shower head according to claim 2, wherein the cyclic switch component is disposed with a driving pawl seat sleeved on the one-way driving pawl; the internal periphery of the dial button is disposed with a protruding block fitting to the one-way driving pawl; when the dial button swags to one side, the protruding block abuts against the one-way driving pawl to drive the one-way driving pawl to rotate; when the dial button swags to another side, the protruding block rotates to leave away from the one-way driving pawl, thus releasing the abutting and fitting relationship of the one-way driving pawl and the protruding block.

4. The multifunctional shower head according to claim 3, wherein the cyclic switch component is further disposed with an one-way intermittent driving element, one end of the one-way intermittent rotating element is fixedly connected to the driving pawl seat, the other end of the one-way intermittent rotating element is connected to the water diversion plate; the one-way intermittent driving element drives the water diversion plate to rotate in one-way intermittently.

5. The multifunctional shower head according to claim 4, wherein the one-way intermittent rotating element is disposed with a switch pawl and a ratchet wheel sleeved on the switch pawl, the internal periphery of ratchet wheel is disposed with internal ratchets coupling to the switch pawl; when the switch pawl rotates towards the direction abutting against the internal ratchet, the ratchet wheel rotates a certain angle corresponding to the internal ratchet.

6. The multifunctional shower head according to claim 5, wherein the external periphery of the ratchet wheel is further disposed with an external ratchet with equal size with the internal ratchet and opposite direction; a stop pawl is configured to abut against the external ratchet.

7. The multifunctional shower head according to claim 5, wherein the one-way intermittent rotating element further comprises a switch pawl seat to hold the switch pawl, the switch pawl seat is fixedly connected to a tension spring; when the switch pawl rotates towards the direction abutting against the internal ratchet, the tension spring is pulled.

8. The multifunctional shower head according to claim 1, wherein the water stop fitting element is a cam coaxially linked to the dial button.

9. The multifunctional shower head according to claim 8, wherein the water stop switch component comprises a rotating block, the side of the rotating block facing to the cam is disposed with an incline surface; when the dial button swags towards the other side, the cam rotates towards the rotating block, so that the cam abuts against the incline surface to drive the rotating block to rotate about the pivot of the rotating block; the rotating block rotates to abut against the water stop valve to make the water stop valve move from the first position to the second position, so that the high volume inlet in the shower head main body is closed.

10. The multifunctional shower head according to claim 9, wherein the water stop valve is disposed with a low volume inlet with continuously water flowing, a Y-shaped ring is disposed between the valve body of the water stop valve and the internal wall of the shower head main body; when the Y-shaped ring is disposed faced to the low volume inlet, water flows to the shower head main body through the low volume inlet to achieve low volume water stop; when the Y-shaped ring is disposed opposite to the low volume inlet, water is stopped by the Y-shaped ring after flowing through low volume inlet to achieve fully water stop.

11. The multifunctional shower head according to claim 9, wherein the water stop valve is connected to the reset spring, when the abutting of the cam and the rotating block is released, the reset spring drives the water stop valve to reset to the first position from the second position.
